(19) United States
(12) Patent Application Publication
(10) Pub. No.: US 2020/0150688 A1
(43) Pub. Date: May 14, 2020

(54) MOVABLE BODY AND REMOTE GUIDANCE SYSTEM

(71) Applicant: TOYOTA JIDOSHA KABUSHIKI KAISHA, Toyota-shi (JP)

(72) Inventors: Yusuke HARA, Nagoya-shi (JP); Takeshi KAMA, Nagakute-shi (JP); Hiroshi HIRAIWA, Toyota-shi (JP); Takahiro SHIGA, Chiryu-shi (JP)

(73) Assignee: TOYOTA JIDOSHA KABUSHIKI KAISHA, Toyota-shi (JP)

(21) Appl. No.: 16/656,662

(22) Filed: Oct. 18, 2019

(30) Foreign Application Priority Data
Nov. 9, 2018 (JP) 2018-211092

(51) Int. Cl. G05D 1/02; H04B 7/26; G06F 13/10

(52) U.S. Cl. CPC G05D 1/0297; G05D 2201/0212; G06F 13/10; H04B 7/26

(57) ABSTRACT

A movable body moves with a user allowed to ride the movable body, and includes: an image display unit that displays an image received from a guide terminal; a sound output unit that outputs a sound received from the guide terminal; a sound acquisition unit that acquires a sound around the movable body; and a sound information transmission unit that transmits the acquired sound to the guide terminal.

### INCORPORATION BY REFERENCE

The disclosure of Japanese Patent Application No. 2018-211092 filed on Nov. 9, 2018 including the specification, drawings and abstract is incorporated herein by reference in its entirety.

### BACKGROUND

### 1. Technical Field

The present invention relates to a movable body such as a small vehicle, and a remote guidance system using the movable body.

### 2. Description of Related Art

One-seater and two-seater small vehicles are being utilized in various scenes. In particular, they are advantageous in tourist spots and the like since touring a wider area can be achieved by them in a shorter time than by foot. In tourist spots and the like, guidance by guides can improve satisfactory sightseeing. In general, such guidance is implemented by a method of providing information via a terminal held by a user, as in art museums and trade shows, as well as by a method in which a guiding person actually goes along. For example, Japanese Patent Application Publication No. 2002-175474 discloses a system of providing information, of an exhibit, which is wanted by a user in a trade show to a mobile terminal of the user.

### SUMMARY

The system disclosed in JP 2002-175474 A however can only unilaterally provide information prepared in advance on each exhibit, and cannot appropriately provide information that the user wants to know at that time as if a guiding person actually went along with him/her. Meanwhile, the number of guiding persons is limited, and the number of users who guiding persons can be actually go along with is limited.

Therefore, an object of the present disclosure is to enable a guidance service to be provided as if a guiding person went along to perform guidance even when the guiding person cannot actually go along.

A movable body according to the present disclosure moves with a user allowed to ride the movable body, and includes: an image display unit that displays an image received from a guide terminal; a sound output unit that outputs a sound received from the guide terminal; a sound acquisition unit that acquires a sound around the movable body; and a sound information transmission unit that transmits the acquired sound to the guide terminal.

A remote guidance system according to the present disclosure includes: a plurality of movable bodies each of which moves with a user allowed to ride the movable body; a plurality of guide terminals that are operated by respective guiding persons; and a server that assigns one guide terminal to each movable body, wherein each of the movable bodies includes: an image display unit that displays an image received from the assigned guide terminal; a sound output unit that outputs a sound received from the assigned guide terminal; a sound acquisition unit that acquires a sound around the movable body; and a sound information transmission unit that transmits the acquired sound to the assigned guide terminal.

According to the present disclosure, a guidance service is enabled to be provided as if a guiding person went along to perform guidance even when the guiding person cannot actually go along.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram showing a configuration of a remote guidance system 1000 according to an embodiment of the present disclosure;

FIG. 2 is diagram exemplarily showing an overall configuration of a movable body 1 according to an embodiment of the present disclosure;

FIG. 3 is a diagram having an upper part of an operation column 4 of a movable body 1 according to an embodiment of the present disclosure expanded;

FIG. 4 is a block diagram showing a system configuration of a movable body 1 according to an embodiment of the present disclosure;

FIG. 5 is a block diagram showing a configuration of a guide terminal 50 according to an embodiment of the present disclosure;

FIG. 6 is a block diagram showing a configuration of a server 60 according to an embodiment of the present disclosure; and

FIG. 7 is a flowchart of a flow of a guidance service with a remote guidance system 1000 according to an embodiment of the present disclosure.

### DETAILED DESCRIPTION OF EMBODIMENTS

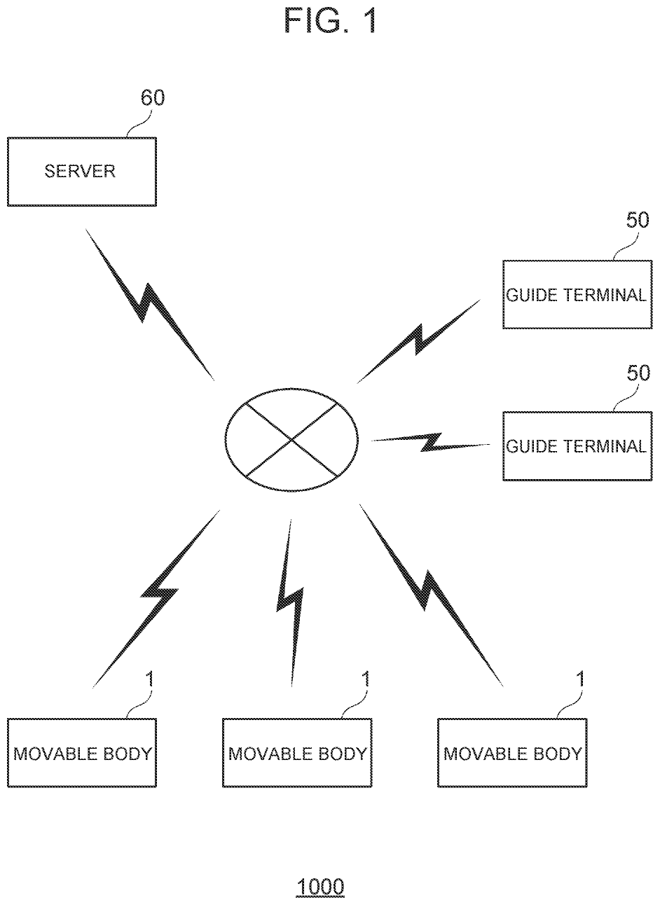

Next, modes for implementing the present disclosure are described in detail with reference to the drawings. FIG. 1 is a block diagram showing a configuration of a remote guidance system 1000 according to an embodiment of the present disclosure. As shown in FIG. 1, the remote guidance system 1000 includes movable bodies 1, guide terminals 50 and a server 60. The server 60 is installed in a management center or the like of the remote guidance system 1000, and connected to the movable bodies 1 and the guide terminals 50 via a communication line. The communication line may be exemplarily the Internet, a LAN, a dedicated line, a telephone line, an office network, a mobile communication network, Bluetooth (R), Wi-Fi, or a combination of any of those, and may be in any of a wired mode and a wireless mode.

There is exemplarily described for the present embodiment a guidance service remotely performed by a guide (guiding person) for a user of a guided tour who rides a movable body 1 to move around in a tourist spot, the guide not actually going along with the user. The guide terminal 50 may be installed in an operation center or the like, or may be placed at the home of the guide, at a site outside the same, or the like. Notably, the present disclosure is not limitedly applied to guided tours for tourist spots, but may be applied to any services which guiding persons remotely provide for users with guidance and information provision in exhibitions, trade shows, event venues and the like.

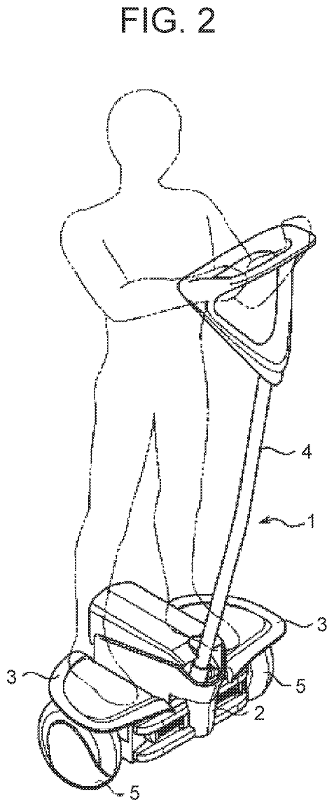

FIG. 2 is a diagram exemplarily showing an overall configuration of the movable body 1 according to an embodiment of the present disclosure. As shown in FIG. 2, the movable body 1 includes a vehicle body 2, a pair of a right step part 3 and a left step part 3 which are attached to the vehicle body 2 and on which an occupant steps, an operation column 4 which is tiltably attached to the vehicle body 2 and which the occupant grabs, and a pair of a right drive wheel 5 and a left drive wheel 5 which are rotatably attached to the vehicle body 2.

The movable body 1 is configured, for example, as a coaxial two-wheel vehicle in which the drive wheels 5 are coaxially arranged and which travels with its upright state maintained. The movable body 1 is configured to travel forward and rearward by the occupant moving the center of gravity forward and rearward to incline the step parts 3 of the vehicle body 2 forward and rearward, and to turn rightward and leftward by the occupant moving the center of gravity rightward and leftward to incline the step parts 3 of the vehicle body 2 rightward and leftward. Notably, not only the coaxial two-wheel vehicle as mentioned above is applied to the movable body 1, but also any movable body that travels with its upright state maintained can be applied thereto.

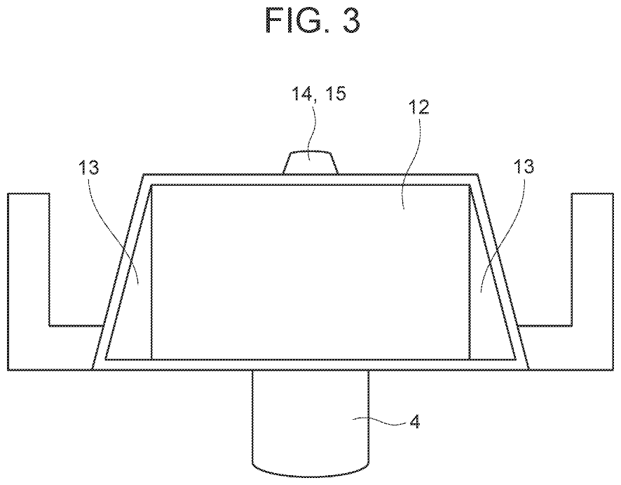

FIG. 3 is a diagram having an upper part of the operation column 4 of the movable body 1 expanded. As shown in FIG. 3, there are installed in the upper part of the operation column 4 a display (image display unit) 12, a loudspeaker (sound output unit) 13, a camera (image acquisition unit) 14 and a microphone (sound acquisition unit) 15. The camera 14 is installed so as to be able to capture an image of a scene which the occupant actually sees.

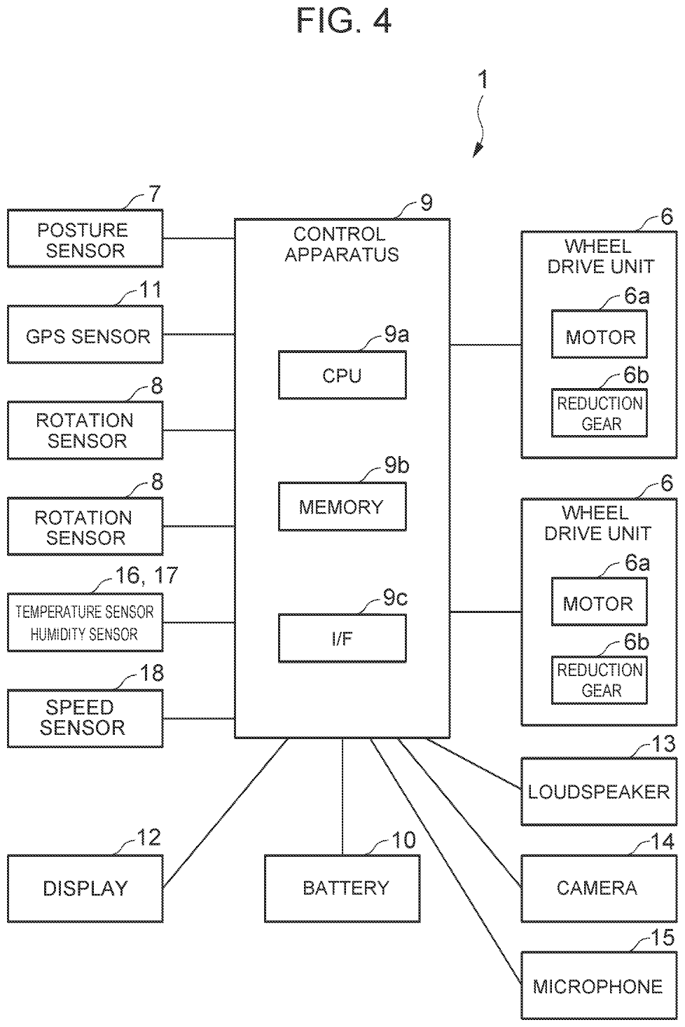

FIG. 4 is a block diagram showing a system configuration of the movable body 1. The movable body 1 includes a pair of wheel drive units 6 which drive the respective drive wheels 5, a posture sensor 7 which detects a posture of the vehicle body 2, a pair of rotation sensors 8 which detect rotation information of the respective drive wheels 5, a control apparatus (a sound information transmission unit, an image information transmission unit, a positional information transmission unit, a weather information transmission unit and a speed information transmission unit) 9 which controls the individual wheel drive units 6, a battery 10 which supplies electric power to the wheel drive units 6 and the control apparatus 9, a GPS sensor (positional information acquisition unit) 11 which senses positional information, the display 12, the loudspeaker 13, the camera 14, the microphone 15, a temperature sensor (weather information acquisition unit) 16, a humidity sensor (weather information acquisition unit) 17, and a speed sensor (speed information acquisition unit) 18.

The wheel drive units 6 are built in the vehicle body 2 and respectively drive the pair of the right drive wheel 5 and the left drive wheel 5. Each of the wheel drive units 6 may include a motor 6a and reduction gear 6b.

The posture sensor 7 is provided in the vehicle body 2 and configured, for example, of a gyrosensor, an acceleration sensor and the like. When the occupant inclines the operation column 4 forward or rearward, the step parts 3 are inclined in the same direction. The posture sensor 7 detects posture information corresponding to this inclination, and outputs the detected posture information to the control apparatus 9.

The rotation sensors 8 are provided at the respective drive wheels 5 or the like, and detect rotation information of rotational angles, rotational angular velocities, rotational angular accelerations and the like of the respective drive wheels 5. The rotation sensors 8 are configured, for example, of rotary encoders, resolvers and the like. The rotation sensors 8 output the detected rotation information to the control apparatus 9.

The battery 10 is exemplarily built in the vehicle body 2 and configured of a lithium ion storage battery and the like. The battery 10 supplies electric power to the wheel drive units 6, the control apparatus 9, other electronic devices and the like.

The control apparatus 9 includes a CPU 9a, a memory 9b such as a ROM and a RAM, an input/output interface and a communication interface (I/Fs) 9c, and the like. Moreover, a storage apparatus such as a hard disk drive may be included. The control apparatus 9 realizes various functions by the CPU executing a program stored in the ROM or the like. The control apparatus 9 performs predetermined calculation processing, for example, on the basis of the posture information output from the posture sensor 7, the rotation information of the drive wheels 5 output from the rotation sensors 8, and other information, and outputs necessary control signals to the wheel drive units 6. Moreover, on the basis of the positional information of the movable body 1 output from the GPS sensor 11, and the posture information output from the posture sensor 7, an image for presentation is displayed on the display 12, and/or a sound for presentation is output from the loudspeaker 13.

The GPS sensor 11 measures current positional information of the movable body 1. The GPS sensor 11 is exemplarily a part of a positional information measurement system using artificial satellites, and highly accurately measures the position (the longitude, the latitude and the altitude) of any point on the earth by receiving radio waves from many GPS satellites.

The display 12 displays an image for the occupant on the basis of a signal from the control apparatus 9. The display 12 displays an image, regarding guidance information, which is transmitted, for example, from the guide terminal 50.

The loudspeaker 13 provides sound information for the occupant on the basis of a signal from the control apparatus 9. The loudspeaker 13 outputs a sound, regarding the guidance information, which is transmitted, for example, from the guide terminal 50.

The camera 14 captures a video image in the field of view of the occupant. The captured video image is transmitted to the guide terminal 50. Notably, the camera 14 may be installed in the main body of the movable body 1, or may be installed on a helmet or the like which the occupant wears.

The microphone 15 picks up occupant's voice, ambient sounds and the like. Sound data picked up by the microphone 15 is transmitted to the guide terminal 50. Notably, the microphone 15 may be installed in the main body of the movable body 1, or may be installed on the helmet or the like which the occupant wears.

The temperature sensor 16 and the humidity sensor 17 respectively measure a temperature and a humidity around the movable body 1 to supply them to the control apparatus 9. Information of the measured temperature and humidity is transmitted to the guide terminal 50.

The speed sensor 18 measures a moving speed of the movable body 1 to supply it to the control apparatus 9. Measured speed information is transmitted to the guide terminal 50.

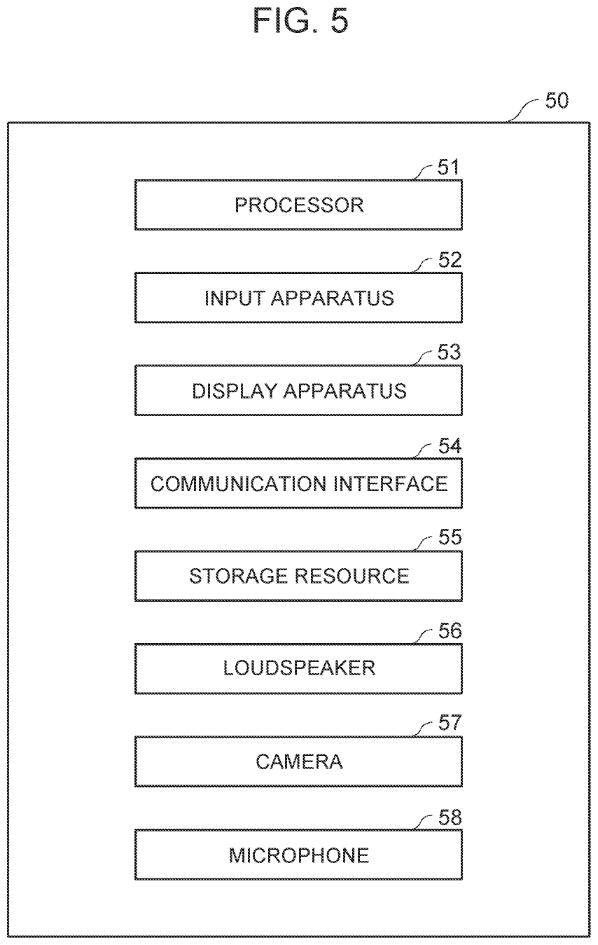

The guide terminal 50 is a terminal used by the guide for guiding the occupant of the movable body 1, and is a terminal, such as a laptop personal computer (PC), a tablet terminal and a smartphone, which can communicate with the server 60 via the communication line. FIG. 5 is a block diagram showing a configuration of the guide terminal 50. As shown in FIG. 5, the guide terminal 50 includes a processor 51, an input apparatus 52 such as a keyboard, a mouse, various operation buttons and a touch panel, a display apparatus 53 such as a liquid crystal display, a communication interface 54 for connection to the communication line, a storage resource 55 such as a disk drive or a semiconductor memory (such as a ROM and a RAM), a loudspeaker 56, a camera 57 and a microphone 58. The storage resource 55 stores a computer program executed by the processor 51.

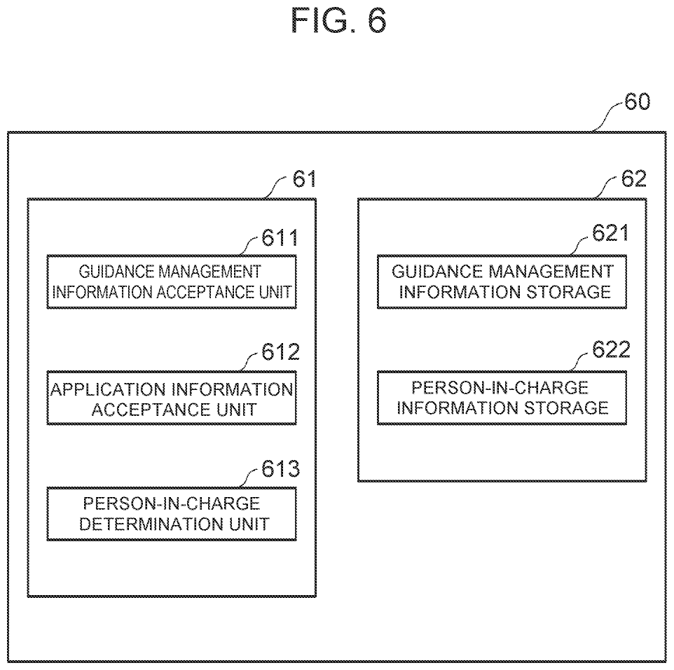

FIG. 6 is a block diagram showing a configuration of the server 60. The server 60 includes a control apparatus 61 and an external storage apparatus 62. The control apparatus 61 includes a CPU, a memory such as a ROM and a RAM, an input interface, an output interface, a communication interface, a bus connecting these to one another, and the like. The control apparatus 61 realizes various functions by the CPU executing a program stored in the ROM or the like. The external storage apparatus 62 is a hard disk drive or the like. Functional modules executed by the CPU of the control apparatus 61 include a guidance management information acceptance unit 611, an application information acceptance unit 612 and a person-in-charge determination unit 613.

Moreover, there are implemented in the external storage apparatus 62 a guidance management information storage 621 and a person-in-charge information storage 622. There is registered in the guidance management information storage 621 information of applicable areas, applicable schedules and the like of guiding persons. For example, there is registered for a recode of a guide A information of an applicable area “Asakusa”, an applicable schedule “November 2 to November 7”, and the like. Each guiding person registers such pieces of information via a terminal connectable to the server 60, such as his/her holding terminal. The server 60 accepts the pieces of information at the guidance management information acceptance unit 611, and registers them in the guidance management information storage 621.

There is registered in the person-in-charge information storage 622 information of a guide in charge assigned to each person (user) participating in a tour. There is exemplarily registered information of a user “X”, a guided area “Asakusa”, date and time “November 3”, a guide in charge “A” and the like. Notably, one guide does not need to take charge of only one user, but can be registered as a guide in charge simultaneously for a plurality of users as long as their areas and dates and times coincide with one another.

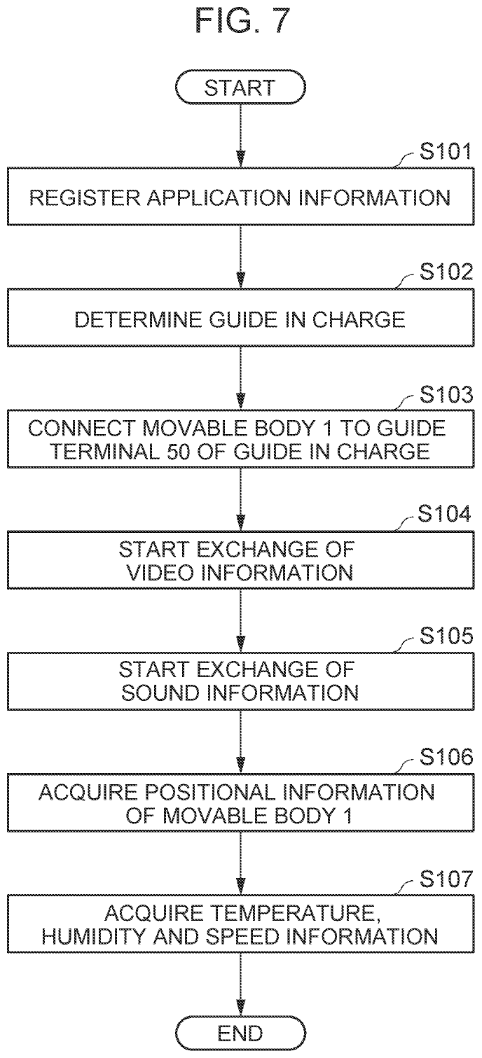

Next, a flow of a guided tour with the remote guidance system 1000 is described using a flowchart of FIG. 7.

A user who wants remote guidance registers application information in the remote guidance system 1000 in advance. The registration is performed via a terminal connectable to the server 60 via the communication line, such as his/her own terminal, and a terminal installed in a store of a company providing the guided tour. Specifically, the user operates the terminal to register the application information. The application information includes information of an area in which guidance is wanted (for example, “Asakusa”) and date and time when the guidance is wanted (for example, “November 3”) and other information as well as a name and contact information (step S101). The server 60 accepts the application information at the application information acceptance unit 612.

The person-in-charge determination unit 613 of the server 60 matches the accepted application information with the information, of each guide, which is registered in the guidance management information storage 621, and determines a guide who applies to conditions as a guide in charge (step S102). Specifically, there is selected a guide whose applicable area coincides with the area in which the user wants to be guided and who is applicable to the date and time which the user wants. There is registered in the person-in-charge information storage 622 information of a combination of the user and the guide in charge thus determined.

On the day of the guided tour, the user rides the lent movable body 1 to start a tour in the area beforehand wanted. Upon the start of the tour, the server 60 connects the movable body 1 and the guide terminal 50 of the guide in charge to each other on the basis of the information registered in the person-in-charge information storage 622 (step S103). When the guide in charge takes charge of a plurality of users, the guide terminal 50 of the guide in charge is connected to each movable body 1.

After the movable body 1 and the guide terminal 50 are connected to each other, they can exchange the video image between them (step S104). Specifically, the video image captured by the camera 14 of the movable body 1 (for example, the video image of a scene which the user sees) is displayed on the display apparatus 53 of the guide terminal 50. When the guide in charge takes charge of a plurality of users, a screen of the display apparatus 53 may be segmented, for example, into the number of the persons, so that the video images received from the individual movable bodies 1 are displayed. Moreover, the video images from the individual movable bodies 1 may be switched and displayed by the guide in charge operating the guide terminal 50.

Moreover, the video image captured by the camera 57 of the guide terminal 50 (for example, the video image of the guide in charge) is displayed on the display 12 of the movable body 1. Moreover, images of a map, guidance information and the like of surroundings may be switched and displayed by the guide in charge operating the guide terminal 50.

Moreover, the user and the guide in charge can have a conversation with each other using the loudspeaker 13 and the microphone 15 of the movable body 1 and the loudspeaker 56 and the microphone 58 of the guide terminal 50 (step S105). When the guide in charge takes charge of a plurality of users, operation of the guide terminal 50 by the guide in charge may conduct conversations with the users on the individual movable bodies 1.

Furthermore, the information of a current position, of the movable body 1, which is measured by the GPS sensor 11 of the movable body 1 is transmitted to the guide terminal 50, and the current position is displayed on the display apparatus 53 (step S106).

Moreover, the information of the ambient temperature and humidity measured by the temperature sensor 16 and the humidity sensor 17 of the movable body 1, and the information of the moving speed measured by the speed sensor 18 are also transmitted to the guide terminal 50, and displayed on the display apparatus 53 and the like (step S107).

The guide in charge can perform the guidance, feeling as if he/she went along with each user, by exchange of the video image via the camera and the display and exchange of the sound via the microphone and the loudspeaker.

According to the present embodiment as above, the movable body 1 and the guide terminal 50 are connected to each other via the communication line, and the guide remotely performs the guidance by exchange of the sounds via the microphone and the loudspeaker with the guidance image and the like being displayed on the display 12 of the movable body 1. Thereby, there can be provided a service of close guidance which is flexible as if the guide went along to perform the guidance even when the guide cannot actually go along. The guidance can be performed using guide's knowledge and experience, in particular, even when it is difficult for him/her to go along for his/her age and/or health reasons. Moreover, one guide can guide a plurality of users in the same time zone due to unnecessity to go along with them, which is able to relieve shortage of guides, and moreover, which is suitable for guidance for a group of a lot of members or the similar situation.

Moreover, since the guide can perform the guidance, watching the video image captured by the camera 14 installed in the movable body 1 on the guide terminal 50, appropriate guidance can be performed with the scene which the user actually sees being confirmed. For example, when the user asks the guide about an article seen in the middle of his/her stroll and even when he/she does not know its name or the like and hardly verbally explains it, the guide can explain it with reference to the video image which the user actually sees.

Moreover, since the information of the current position measured by the movable body 1 is transmitted to the guide terminal 50, the guide can grasp the accurate current position of the movable body 1. Thereby, appropriate guidance can be performed even when the location of the user is not apparent from the video image from the camera 14 or what he/she tells.

Moreover, since the temperature and humidity around the movable body 1 are measured and transmitted to the guide terminal 50, the guide can grasp the weather, temperature and the like at that site to provide an appropriate suggestion to the user. For example, guiding into an indoor facility or other guiding can be performed when it seems to rain or when the temperature is high or low.

Moreover, the server 60 manages the information of the applicable area, the applicable schedule and the like of the guide, matches the area and the date and time registered by the user with the applicable area and schedule of each guide, and thereby, the guide who is assigned to the user is determined. Thereby, an appropriate guide can be efficiently determined.

Moreover, the guide may be able to remotely operate the camera 14 installed in the movable body 1. For example, the guide may operate the camera 14 to take a commemorative photograph of the user. Specifically, the user stands in front of the camera 14, and the guide takes the photograph, adjusting an orientation and zoom of the camera 14 while monitoring the image transmitted from the camera 14. The taken photograph may be transmitted to a mobile terminal owned by the user or the similar device.

Moreover, the video image captured by the camera 14 of the movable body 1 during the tour may be transmitted to the mobile terminal owned by the user or the similar device. The user can release the captured video image on a social networking service (SNS) or the like.

Notably, the present disclosure is not limited to the aforementioned embodiments, but can be implemented in various other modes without departing from the scope and spirit of the present disclosure. Therefore, the aforementioned embodiments are merely exemplary in all senses and should not be limitedly construed. For example, the processing steps mentioned above can be performed in any different order or in parallel as long as any inconsistency does not arise on the processing details.

What is claimed is:

1. A movable body that moves with a user allowed to ride the movable body, the movable body comprising:
an image display unit that displays an image received from a guide terminal;
a sound output unit that outputs a sound received from the guide terminal;
a sound acquisition unit that acquires a sound around the movable body; and
a sound information transmission unit that transmits the acquired sound to the guide terminal.

2. The movable body according to claim 1, comprising:
an image acquisition unit that acquires an image around the movable body; and
an image information transmission unit that transmits the acquired image to the guide terminal.

3. The movable body according to claim 1, comprising:
a positional information acquisition unit that acquires a current position of the movable body; and
a positional information transmission unit that transmits the current position to the guide terminal.

4. The movable body according to claim 1, comprising:
a weather information acquisition unit that acquires weather information including at least one of a temperature and a humidity around the movable body; and
a weather information transmission unit that transmits the weather information to the guide terminal.

5. The movable body according to claim 1, comprising:
a speed information acquisition unit that acquires information of a moving speed of the movable body; and
a speed information transmission unit that transmits the moving speed to the guide terminal.

6. A remote guidance system comprising:
a plurality of movable bodies each of which moves with a user allowed to ride the movable body;
a plurality of guide terminals that are operated by respective guiding persons; and
a server that assigns one guide terminal to each movable body, wherein each of the movable bodies includes:
an image display unit that displays an image received from the assigned guide terminal;
a sound output unit that outputs a sound received from the assigned guide terminal;
a sound acquisition unit that acquires a sound around the movable body; and
a sound information transmission unit that transmits the acquired sound to the assigned guide terminal.

7. The remote guidance system according to claim 6, wherein
the server includes:
a guidance management information acceptance unit that accepts registration of information of a guidable area and applicable date and time of each guiding person;
an application information acceptance unit that accepts registration of information of an area in which the user wants to be guided and date and time when the user wants to be guided; and
a person-in-charge determination unit that determines the guiding person assigned to the user by matching the area and the date and time that are registered by the user with the area and the date and time that are registered by each guiding person.
